(19) United States
(12) Patent Application Publication
(10) Pub. No.: US 2016/0091366 A1
(43) Pub. Date: Mar. 31, 2016

(54) AUTO-FOCUS RAMAN SPECTROMETER SYSTEM

(71) Applicants: Frank Jiann-Fu Yang, Vista, CA (US); Ke-Yi Wang, Taichung City (TW)

(72) Inventors: Frank Jiann-Fu Yang, Vista, CA (US); Ke-Yi Wang, Taichung City (TW)

(21) Appl. No.: 14/497,307

(22) Filed: Sep. 25, 2014

(51) Int. Cl. G01J 3/02; G01J 3/44; G01J 3/10

(52) U.S. Cl. CPC G01J 3/0237; G01J 3/10; G01J 3/4412

(57) ABSTRACT

An autofocus Raman spectrometer system includes a laser probe assembly, a microprocessor, adjustable stages and a driving means. The laser probe assembly includes an excitation means, a focusing optics provided to focus an excitation beam from the excitation means onto a sample and generate Raman scattering spectrum, a collection optics for collecting the Raman scattering spectrum, and a spectrographic detector for generating a Raman spectrum based on the Raman scattering intensity received from the collection optics. The microprocessor receives the Raman spectra signal therefrom. The laser probe assembly is situated on the adjustable stage. The driving means is coupled to the microprocessor and configured to drive the stage to move with respect to the sample. The microprocessor generates a command to the driving means for moving a position of the adjustable stage to achieve an optimal optical focus based on signal intensity of the spectra peaks measured by the spectrographic detector.

### BACKGROUND OF THE INVENTION

1. Field of the Invention

The present invention relates to the field of Raman spectrometry instrumentation used for material identification and quantification. The instrument can be used to analyze solid, liquid, and gas. More particularly, the present invention relates to a Raman spectrometer system having means for automatically adjusting the position of either a sample holding stage or a Raman spectrometer mounting stage for focusing on the sample molecules to obtain maximum Raman spectra intensity.

2. Description of the Related Art

A conventional instrumentation used for laser focusing in Raman spectroscopy is a spectroscopic microscope system 900 as shown in FIG. 6. The microscope system 900 includes an optical microscope shown in simplified form within the dashed lines labeled 80. The microscope 80 includes an object lens 81 and an ocular lens 82 which may be utilized for direct viewing by an observer. Light from a sample located at a sample position 83 is thus passed back through the object lens 81 to the ocular lens 82 on a beam path 84 in a conventional fashion to form an image that can be viewed by the operator directly.

On the other hand, an illuminating laser beam 71 is provided from a light source 70 to a mirror 72 which redirects the illuminating beam 71 on a path toward the mirror 73. The mirror 73 deflects the illuminating beam 71 onto a path coincident with the microscope beam path 84. The object lens 81 focuses the illuminating beam 71 onto a focal point 85, thereby causing sample at this point to interact with the illuminating beam 71 and scatter, emit, or otherwise deliver light having different wavelength content along a return beam path 91 after being collected by the object optical element 81. The return beam 91 is deflected by the mirror 73 onto a path coincident with the illuminating beam path 71, and is allowed to pass through the dichroic mirror 72 that is chosen to pass wavelengths along one or more ranges other than those of the illuminating beam 71. The return beam 91 passes through an input lens 92 which focuses the beam 91 onto the spectrograph input aperture 93 of spectrograph 94. The spectrograph 94 may be formed to spatially distribute the wavelengths of light in the return beam 91, with the wavelengths then being incident upon a detector 95 which detects the intensity of the light at the various wavelengths to provide an output signal which characterizes properties of the sample molecules. The resulting analog signal from the CCD sensor 95 is converted to a digital signal using an A/D converter (not shown) and displayed on a computer 96 as a Raman spectrum of the sample molecules.

The foregoing arrangement is beneficial, but it still has shortcomings. As can be understood, the conventional system combines a microscope and a Raman spectrometer together, which makes it relatively complex in structure. Proper optical alignments among the two are highly required. Besides, when using the system 900, the user is responsible for attaining proper focus of the sample by manually moving the object lens to the sample. Thus, the Raman measurement becomes relatively time-consuming, inefficient, and operator dependent.

### SUMMARY OF THE INVENTION

Accordingly, it is an object of the present invention to provide an autofocus Raman spectrometer system, which is relatively simple in structure and can perform the Raman spectroscopy measurement in an automated and reproducible manner.

To achieve the foregoing objective, the autofocus Raman spectrometer system includes a laser probe assembly, a microprocessor, an adjustable stage and a driving means. The laser probe assembly includes an excitation means, a focusing optics provided to focus an excitation beam from the excitation means onto a sample to generate Raman scatter, a collection optics for collecting the Raman scatter, and a spectrographic CCD detector for generating a Raman spectrum signal based on the Raman scatter received from the collection optics. The microprocessor is coupled to the spectrographic detector to receive the Raman signal therefrom indicative of an intensity of the Raman scatter detected by the spectrographic detector. Either one of the sample and the laser probe assembly is situated on the adjustable stage. The driving means is coupled to the microprocessor and configured to drive the adjustable stage to move, thereby allowing adjustment of a separation between the sample and the focusing lens of the laser probe assembly for optimal focusing of the laser beam on the sample. In particular, the microprocessor generates a command to the driving means for moving a position of the adjustable stage to achieve an optimal optical focus based on signal peaks of the Raman spectrum signals measured by the spectrographic detector.

Furthermore, benefits and advantages of the present invention will become apparent after a careful review of the detailed description with appropriate reference to the accompanying drawings.

### BRIEF DESCRIPTION OF THE DRAWINGS

FIG. 1 is a perspective view of a robotic controlled autofocus Raman spectrometer system for material identification and quantification in accordance with the preferred embodiment of the present invention;

FIG. 2 is a side view of the autofocus Raman spectrometer system shown in FIG. 1;

FIG. 3 is a block diagram of the autofocus Raman spectrometer system shown in FIG. 1;

FIG. 4 is a plot of Raman signal intensity as a function of stage position;

FIG. 5 illustrates Raman spectrums measured at different positions; and

FIG. 6 is a prior art.

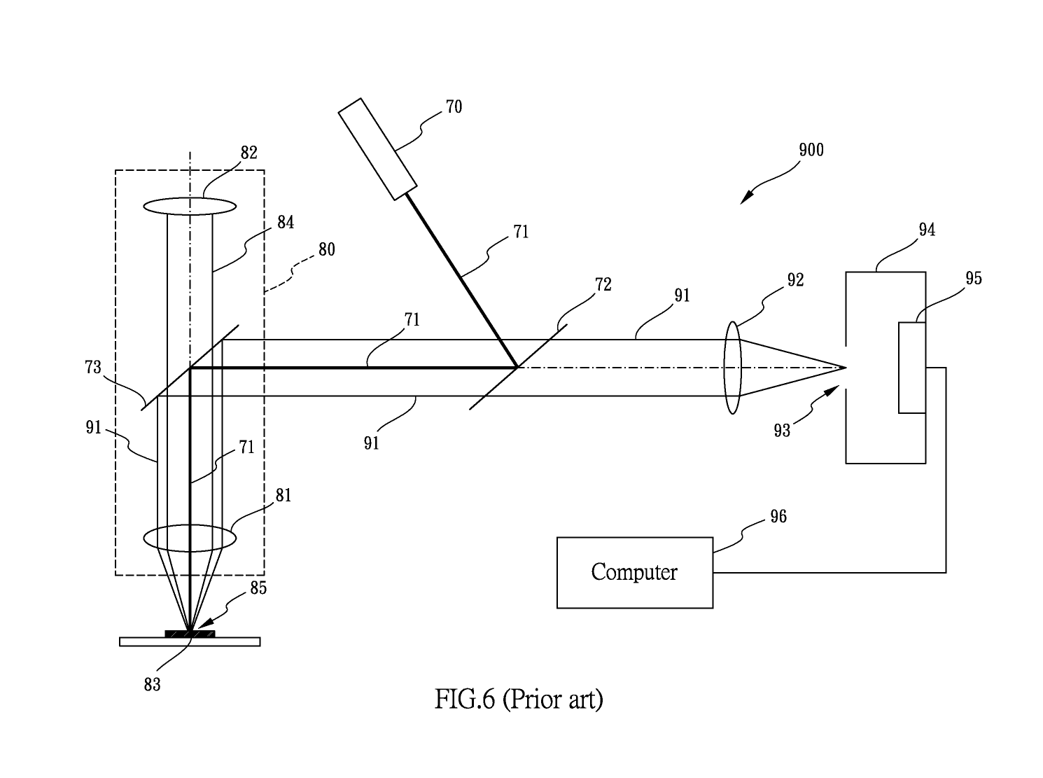

### DETAILED DESCRIPTION OF EMBODIMENTS

Referring now in detail to the drawing, there is shown a robotic controlled autofocus Raman spectrometer system for material identification and quantification, indicated generally at 100, which has been constructed according to the principles of the present invention.

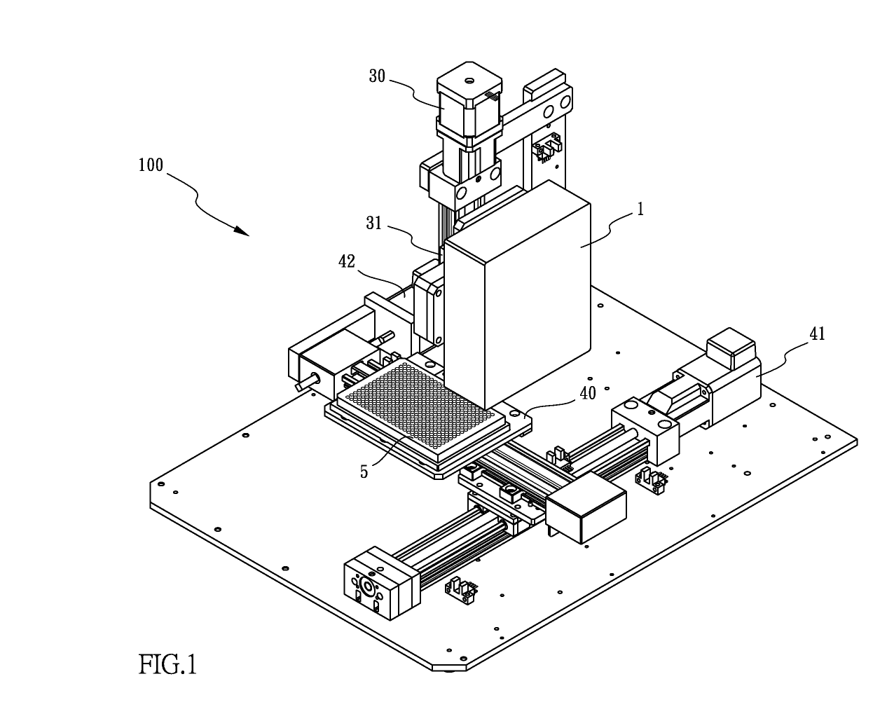

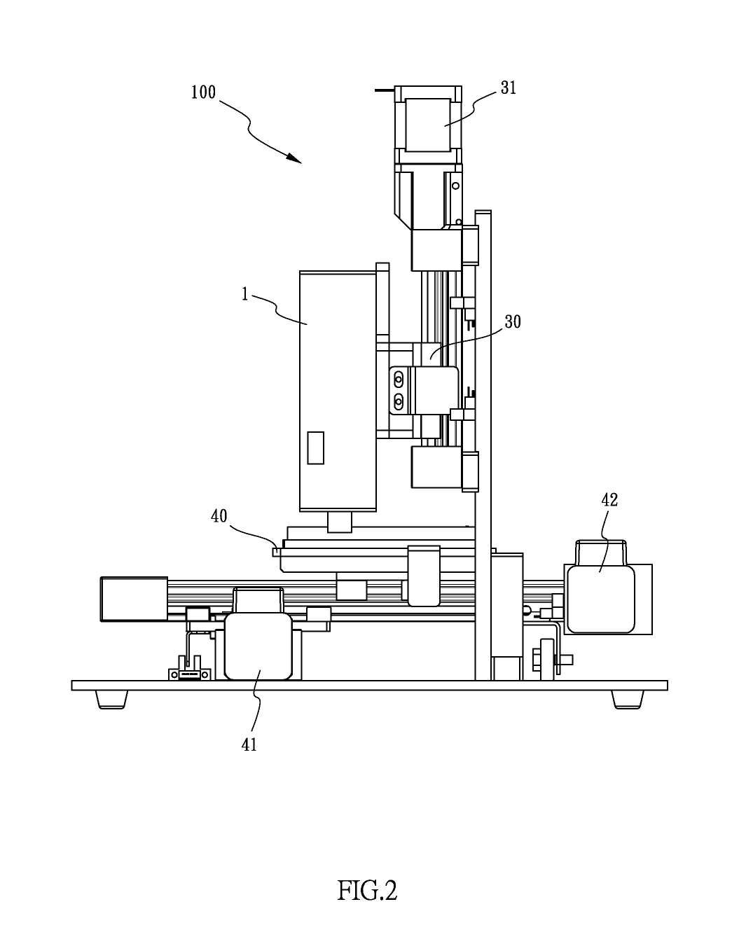

With reference to FIGS. 1 and 2, the autofocus Raman spectrometer system 100 includes a laser probe assembly 1, a computer 2 (not depicted in FIGS. 1 and 2) connected to the laser probe assembly 1, a Z-axis motorized stage 30 on which the laser probe assembly 1 is situated, a Z-axis drive 31 provided for driving the stage 30 to move, a X-Y axis motorized stage 40 on which a sample or sample holder 5, and X-Y axis drives 41, 42, configured for driving the stage 40 to move horizontally. As such, the laser probe assembly 1 is movable with respect to the sample 5. The sample may be in the form of solid, powder, liquid, tablet, sheet, SERS, in vial, or in plastic bag.

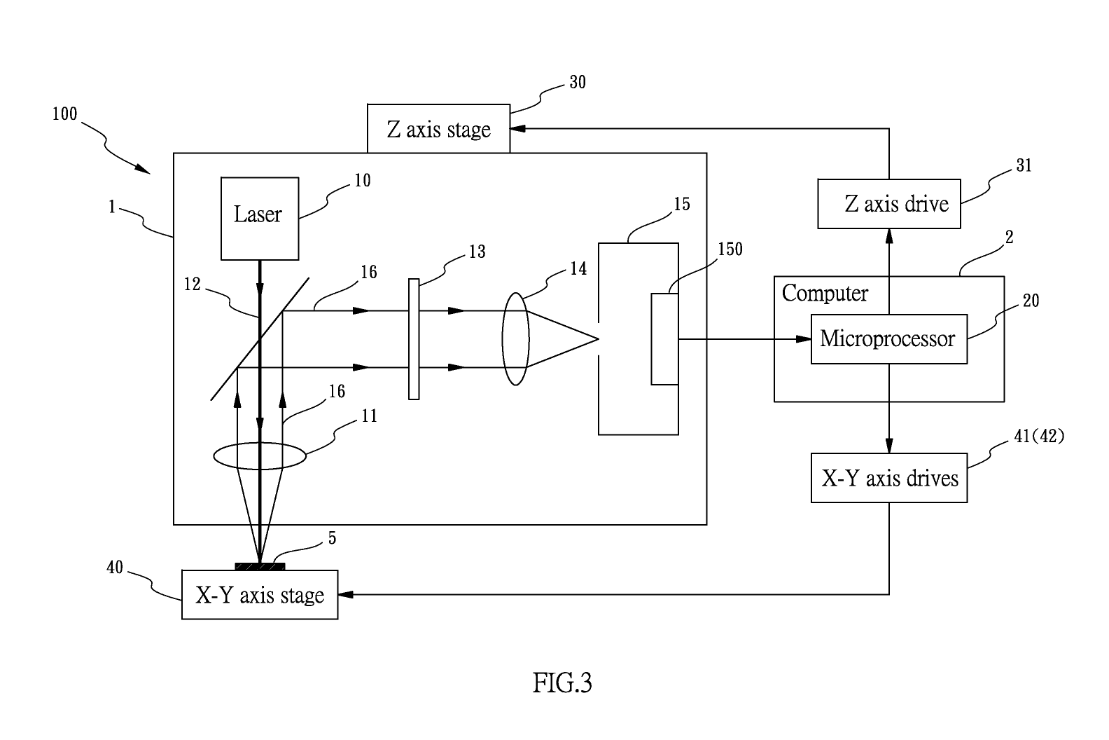

Specifically, as best seen in FIG. 3, the laser probe assembly 1 generally includes an excitation means 10, a focusing optics 11, a notch filter 13, a collection optics 14 and a spectrograph 15. The excitation means 10 is a diode-pumped solid state laser emitting for example at 785 nm, 1064 nm, or 532 nm. Note also that the excitation means, in other example, may be an optics fiber that is connected to an excitation light source so as to output an excitation beam.

The focusing optics 11 is provided to focus an excitation beam 12 generated by the excitation means 10 onto a focal point which is supposed to be coincident with the position of the sample 5. Once the excitation beam 12 is focused onto the sample 5 by the focusing optics 11, any sample at this point interacts with the excitation beam 12 and scatters, emits, or otherwise deliver light to form a Raman scatter 16 having different molecular wavelength content, after being collected by the focusing optics 11. The reflected and collimated Raman scatter 16 is then passed through a notch filter 13 to remove or significantly reduce the intensity of the excitation light (collected as Rayleigh scattered light at the sample). The filtered Raman scatter 16 is then focused and transmitted, using the collection optics 14, to a detector 150 of the spectrograph 15. The spectrographic detector 150 generates a Raman spectrum signal based on the Raman scatter 16 and transmits the Raman spectrum signal to a microprocessor 20 of the computer 2. The microprocessor 20, that is coupled to the spectrographic detector 150, receives the Raman spectrum signal therefrom indicative of an intensity of the Raman scatter detected by the spectrographic detector 150.

As shown in this embodiment, the laser probe assembly 1 is placed on the Z-axis stage 30 having an adjustable position along the Z-axis while the sample 5 is situated on the X-Y axis stage 40. Specifically, the Z-axis stage is a lead-screw-type stage driven by the Z-axis drive 31 in form of a motor, as shown in FIG. 1 or 2. Preferably, a close-loop digital encoder controlled motor drive is employed. The X-Y axis drives 41, 42 are also motors and both may be supplied with power to drive the stage 40 to a desired position, and thereby the sample 5 is movable in two dimensions to be aligned with the focusing lens 11 of the laser probe assembly 1. It should be noted that, in other example, the laser probe assembly 1 may be stationary while the sample 5 is situated on a Z axis stage such that a separation between the sample 5 and the focusing lens 11 of the laser probe assembly 1 can be adjusted.

Referring again to FIG. 3, the Z-axis drive 31 is coupled to the microprocessor 20 of the computer 2 and drives the Z-axis stage 30 to move along the Z axis according to a command from the computer 2, thereby allowing adjustment of a separation between the sample 5 and the focusing lens 11 of the laser probe assembly 1 for optimal autofocusing.

On the other hand, the microprocessor 20 generates the command to the Z-axis drive 31 for moving the position of the Z-axis stage 30 to achieve an optimal optical focus based on signal peaks of the Raman spectrum signals measured by the spectrographic detector 150, as will be discussed in detail later.

In operation, the microprocessor 20 records intensity values of the Raman spectrum signals measured by the spectrographic detector 150 as well as position feedbacks received from the Z-axis stage 30 to find out the maximum Raman molecules spectrum intensity, and based on these received information, moves the Z-axis stage 30 to a position P2 of the signal peak that best correlates to the optimal optical laser focus by commanding the Z-axis drive 31.

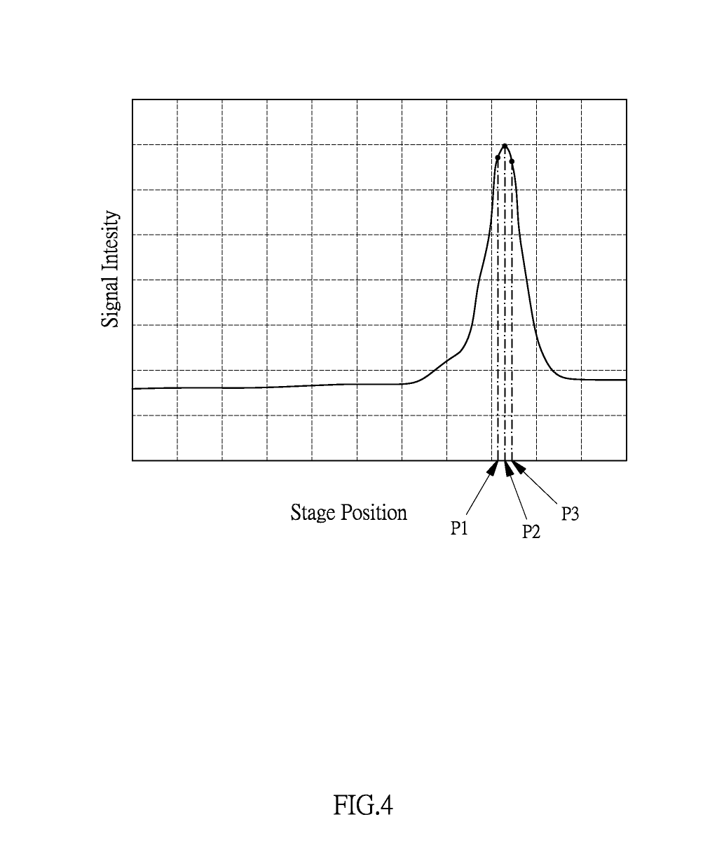

As discussed further below, during the maximum Raman spectrum signal intensity optimization process, the laser probe assembly 1 is moved at different positions along the Z-axis with respect to the sample 5 for generating Raman scatters from which a maximum Raman scatter is to be selected, and the microprocessor 20 records the signal intensity of each of the Raman spectrum signals measured at each position by the spectrographic detector 150 so as to form a signal intensity profile. FIG. 4 shows an example plot of the signal peaks against the position of the Z-axis stage 30. The signal peaks are analyzed by the microprocessor 20 and then the Z-axis stage 30 is commanded to move, by the Z-axis drive 31, to a position where the signal peak best correlates to the desired optical focus.

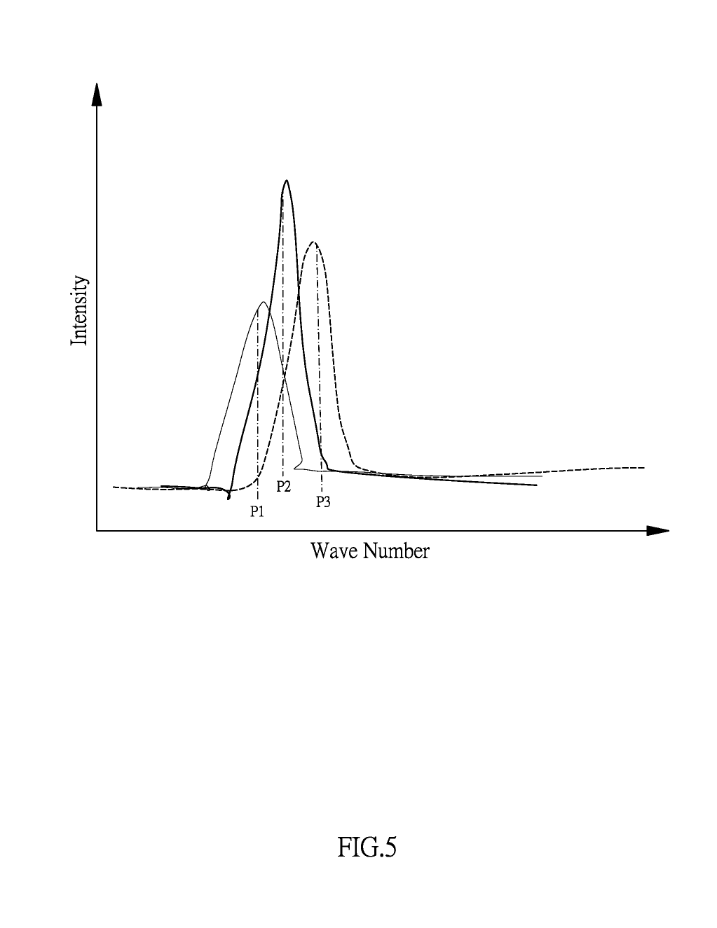

For example, FIG. 5 illustrates three Raman spectrums measured at three different positions P1, P2 and P3. As can be seen from FIGS. 4 and 5, the Raman intensity detected at P1 and P3 are both lower than the maximum intensity detected at P2. It is therefore determined that the position P2 is the one that best correlates to the desired optical focus. And so, if the Z-axis stage 30 is positioned at P2, the laser probe assembly 1 is properly placed and the focal point of the focusing lens 11 is coincident with the sample 5.

Accordingly, the computer 2 with the microprocessor 20 can carry out automatic focusing adjustments utilizing the Z-axis motorized stage 30 under software control so that the focal point of the focusing lens 11 of the laser probe assembly can be exactly focused onto the sample 5 on the stage 40 without the need of a microscope for a manual focusing operation that is needed in the prior art.

What is claimed is:

1. An autofocus Raman spectrometer system, comprising:
a laser probe assembly including an excitation means, a focusing optics provided to focus an excitation beam from the excitation means onto a sample and generate Raman scatter, a collection optics for collecting the Raman scatter, and a spectrographic detector for generating a Raman spectrum signal based on an intensity of the Raman scatter received from the collection optics;
a microprocessor coupled to the spectrographic detector to receive the Raman spectrum signal therefrom;
an adjustable stage whereupon either one of the sample or the laser probe assembly is situated; and
a driving means coupled to the microprocessor and configured to drive the adjustable stage to move, thereby allowing adjustment of a separation between the sample and the focusing lens of the laser probe assembly;
wherein the microprocessor generates a command to the driving means for moving a position of the adjustable stage to achieve an optimal optical focus based on signal peaks of the Raman spectrum signals measured by the spectrographic detector.

2. An autofocus Raman spectrometer system as recited in claim 1, wherein the microprocessor, based on intensity values of the Raman spectrum signals measured by the spectrographic detector as well as position feedbacks received from the adjustable stage, moves the adjustable stage to a position where the signal peak of the Raman spectrum signal best correlates to the optimal optical laser focus, by commanding the driving means.

3. An autofocus Raman spectrometer system as recited in claim 1, wherein the adjustable stage is an Z axis stage on which the laser probe assembly is mounted so that the laser probe assembly is movable with respect to the sample.

4. An autofocus Raman spectrometer system as recited in claim 3, further comprising an X-Y axis motorized stage whereupon the sample is situated, thereby the sample is movable in two dimensions to be aligned with the focusing lens of the laser probe assembly on the Z axis adjustable stage.

5. An autofocus Raman spectrometer system as recited in claim 1, wherein the adjustable stage is a motor-driven lead-screw-type stage.

6. An autofocus Raman spectrometer system as recited in claim 1, the excitation means comprising a laser diode.

7. An autofocus Raman spectrometer system as recited in claim 1, the excitation means is an optical fiber that is connected to an excitation light source so as to output the excitation beam.
